(19) United States
(12) Patent Application Publication
(10) Pub. No.: US 2026/0207423 A1
(43) Pub. Date: Jul. 23, 2026

(54) Vibrating massage ring

(71) Applicant: Dongguan Love Quartet Electronics Technology Co., Ltd., Dongguan (CN)

(72) Inventor: Yulin Luo, Dongguan (CN)

(21) Appl. No.: 19/029,008

(22) Filed: Jan. 17, 2025

(51) Int. Cl. A61H 23/02

(52) U.S. Cl. CPC A61H 23/02; A61H 2201/0188; A61H 2201/0192; A61H 2201/165; A61H 2205/067

(57) ABSTRACT

A vibrating massage ring includes a semi-annular body, a knob assembly located at the top of the semi-annular body, and a silicone sleeve wrapped around the semi-annular body; the silicone sleeve has opposite first end and second end, the firs end is provided with a guiding ring, and the second end can pass through the guiding ring and attach to the first end to form an overlapping area so that the silicone sleeve can surround a wearing cavity; the second end is provided with a string, and the ends of the string are fixedly provided on the knob assembly; the knob assembly is rotated to wind or unwind the string, so as to control the size of the overlapping area of the first end and the second end to adjust the size of the wearing cavity.

### FIELD OF THE INVENTION

The present invention relates to the technical field of massages, particularly, to a vibrating massage ring.

### BACKGROUND OF THE INVENTION

Massage rings are worn on the massage areas of the human body, such as the arms, legs, neck, waist, and abdomen, to massage. The current massage ring has a fixed cavity size and cannot be adjusted. For example, Chinese utility model patent CN215132876U discloses a finger massage ring, which is equipped with a wearing ring, a first pressing part, and a second pressing part. The wearing ring is provided with a massage space, and the first pressing part is fixedly connected to the inner ring of the wearing ring and accommodated in the massage space. The second pressing part is fixedly connected to the outer ring of the wearing ring. The first pressing part is provided with multiple first massage positions, which are uniformly distributed in the circumferential direction and point to the massage space. The second pressing part is provided with multiple second massage positions, which are uniformly distributed in the circumferential direction; The user can pass his fingers through the massage space, and then move back and forth or rotate and twist the finger massage ring. At this time, the first massage position on the first press part massages the surface of the user's fingers, friction and press the nerve endings of the fingers, so as to speed up the blood circulation of the fingers and achieve the effect of soothing a finger.

The current massage ring has a fixed cavity size and cannot be adjusted. This has led to many inconveniences in practical use. For people who are overweight, a fixed size massage ring is not able to be worn in the corresponding area and can only be avoided, unable to enjoy the relaxing experience brought by the massage ring. For people with a smaller body, the massage ring may be too loose when worn, which is easily displacement during massage and make it difficult to accurately apply to the target massage area, greatly reducing the massage effect.

In addition, as people's emphasis on health and wellness continues to increase, the use of massage rings is becoming increasingly diverse. Whether used to relieve muscle fatigue after exercising or to relax the neck and waist during long-term desk work, we hope to have a massage ring that better meets our own needs. However, the existing fixed ring cavity size limits its applicable range, seriously hindering the further expansion of the massage ring market. It can be seen that the development of a massage ring that can adjust the size of the ring cavity is urgently needed.

### SUMMARY OF THE INVENTION

To overcome the shortcomings of the prior art, the disclosure provides a vibrating massage ring, which solves the defect that the size of a wearable cavity cannot be adjusted by the existing massage ring, and is easy to operate.

The technical solution of the disclosure are as follows:

A vibrating massage ring includes a semi-annular body, a knob assembly located at the top of the semi-annular body, and a silicone sleeve wrapped around the semi-annular body; the silicone sleeve has opposite first end and second end, the firs end is connected with the second end so that the silicone sleeve can surround a wearing cavity; the second end is provided with a string, and the ends of the string are fixedly provided on the knob assembly; the knob assembly is rotated to wind or unwind the string, so as to control the size of the overlapping area of the first end and the second end to adjust the size of the wearing cavity.

The outer surface of the semi-annular body is provided with a knot base with a first base hole; the knob assembly is mounted on the knot base and includes the string winding drum and the rotating drum; the string winding drum is cylindrical in shape with a bottom movably defined inside the semi-annular body; two ends of the string are fixed on the bottom of the string winding drum; the rotating drum is cylindrical in shape and sleeved outside the top of the string winding drum, an inner wall of the bottom of the rotating drum is provided with second clamping teeth, and the bottom surface of the rotating drum is provided with third clamping teeth; the knob base is provided with fourth clamping teeth; the first clamping teeth mesh with the second clamping teeth; an external force overcomes the resistance of the fourth teeth to the third teeth, so as to rotate the rotating drum, and the string winding drum is driven to rotate by the cooperation of the second teeth and the first teeth, so that the string is wound around the string winding drum or the string wound around the string winding drum is released, so that the overlapped area between the second end and the first end is increased or decreased, thereby adjusting the size of the wearing cavity.

The knob assembly further includes a fixing plate and a positioning step post; the fixing plate is fixedly disposed in the semi-annular body, and the bottom of the string winding drum is movably disposed on the fixing plate; the bottom of the positioning step post passes through the string winding drum and is fixed to the fixing plate; the step wall of the positioning step post abuts against the top of the string winding drum, a limiting ring is provided on the middle part of the outer wall of the string winding drum, and the outer diameter of the limiting ring is greater than the diameter of the first base hole, the inner surface of the string winding drum is provided with an inner ring, and a silicone ring is provided between the inner ring, the top of the string winding drum and the outer wall of the bottom of the positioning step post, thereby preventing the displacement of the string winding drum from affecting the cooperation of the first clamping teeth and the second clamping teeth.

The firs end is provided with a guiding ring, and the second end can pass through the guiding ring and attach to the first end to form an overlapping area. A silicone coat is provided outside the rotating drum.

At least one annular flange is disposed on an outer wall of the top of the positioning step post, and each annular flange is in an interference fit with the inner surface of the rotating drum; the external force overcomes the friction force between the annular flange and the inner wall of the rotating drum and pulls the rotating drum in a direction away from the knob base, so that the first clamped teeth are separated from the second clamped teeth, and the third clamped teeth are separated from the fourth clamped teeth, thereby releasing the string winding drum; the external force overcomes the friction force between the annular flange and the inner wall of the rotating drum and pushes the rotating drum in the direction of the knob base, so that the first clamping teeth meshed with the second clamping teeth, and the third clamping teeth meshed with the fourth clamping teeth, thereby locking the string winding drum.

A PCB sticking plate is arranged on the top of the positioning step post, a PCB lamp board is fixedly arranged on the PCB sticking plate, a led lamp is arranged on the PCB lamp board.

The outer surface of the semi-annular body is provided with a waterproof silicone seat at a position close to the second end, two through holes penetrate through the side surface of the waterproof silicone base from the bottom surface thereof through which the string penetrates, so that the string is introduced into the interior of the semi-annular body from the exterior thereof.

The second end of the silicone sleeve is fixedly provided with a guiding member extending out of the second end and provided with a string hole for the string to pass through.

The semi-annular body is further provided with a first electric shock member and a second electric shock member penetrating the silicone sleeve.

A battery, a motor, and a PCB board are disposed in the semi-annular body; the battery is arranged below the knob assembly, and the motor and the PCB are respectively arranged at two sides of the battery.

The beneficial effects of the disclosure are as follows: according to the vibration massage ring in the disclosure, the knob assembly is provided with on the top of the semi-annular body, and the silicone sleeve is wrapped on the semi-annular body; the guide ring is provided on the first end of the silicone sleeve, and the second end of the silicone sleeve can be inserted into the guide ring and form a overlapped area with the first end, thereby forming a wearing cavity; the string is provided on the second end, the ends of the string are fixed on the knob assembly, and the knob assembly is rotated to wind and unwind the string to, so as to control the size of a overlapped area formed by the first end and the second end so as to adjust the size of the wearing cavity. The users only needs to rotate the knob assembly, so that the size of the wearable cavity can be precisely adjusted according to the users'demands, and the wearable cavity is perfectly fitted to the massage part of the user, so that the vibration massage ring can be suitable for different users, or can be adjusted according to different requirements on the tightness degree of the massage ring after the same user is worn, and the use is convenient.

The vibrating massage ring is vibrated by a motor, the motor can generate vibration modes of different frequencies and intensities to meet the diversified massage requirements of the users.

The electric shock members on the surface of the silicone sleeve serve to give a person a light shock when massaging, making the users more comfortable.

The silicone sleeve is skin-friendly, soft and breathable, is not only comfortable to the touch, but also can effectively avoid problems such as skin allergies, so that users can wear the vibrating massage ring in a comfortable manner for a long time.

### BRIEF DESCRIPTION OF THE DRAWINGS

In order to explain more clearly the technical scheme in the embodiment of the present invention, a brief introduction is given below to the attached drawings needed in the embodiment. Obviously, the attached drawings in the following description are only some embodiments of the present invention, for ordinary technicians in this field, other drawings can be obtained according to these drawings without paying creative labor.

FIG. 1 is a perspective view of the vibrating massage ring in the disclosure.

FIG. 2 is another perspective view of the vibrating massage ring in the disclosure.

FIG. 3 is an exploded view of the vibrating massage ring in the disclosure.

FIG. 4 is a perspective view of a portion of the vibrating massage ring in the disclosure.

FIG. 5 is a perspective view of a portion of the vibrating massage ring in the disclosure.

FIG. 6 is an exploded view of the vibrating massage ring in the disclosure.

FIG. 7 is a sectional view of the vibrating massage ring in the disclosure.

### DETAILED DESCRIPTION OF ILLUSTRATED EMBODIMENTS

The embodiment of the present invention is described in detail below, and an example of the embodiment is shown in the attached Figs., where the same or similar label from beginning to end represents the same or similar element or element with the same or similar function. The following embodiments described by reference to the attached drawings are exemplary and are intended to be used to explain the embodiments of the present invention, and can not be understood as limiting the present invention.

In the description of the embodiment of the present invention, it needs to be understood that the azimuth or position relation indicated in the term “length ”,“ width ”,“ upper ”,“ lower ”,“ front ”,“ rear ”,“ left ”,“ right ”,“ vertical ”,“ horizontal ”,“ top ”,“ bottom ”,“ inside ”,“ outside” and so on is based on the azimuth or position relation shown in the attached figure, only for the convenience of describing the embodiment and simplifying the description of the present invention, rather than indicating or implying that the device or element must have a specific orientation, construction and operation with a specific orientation, so it can not be understood as a restriction on the present invention.

Furthermore, the terms “first ”,“ second” are used only for descriptive purposes and can not be understood as indicating or implying relative importance or implicitly indicating the number of technical features indicated. Thus, the qualification of “first” and “second” features may include one or more of them explicitly or implicitly. In the description of the embodiment of the present invention, the meaning of “multiple” is two or more, unless otherwise specified.

In the embodiments of the invention, unless otherwise clearly specified and defined, the terms, “installed”, “connected”, “or” fixed” should be generally understood, for example, a fixed connection, or a removable connection, a mechanical connection or an electrical connection, or an directly connection or an indirectly connection through an intermediate media, or a connection within two elements or the interaction of two elements. For those of ordinary skilled in the art, the specific meaning of the above terms in the embodiment of the present invention may be understood under specific circumstances.

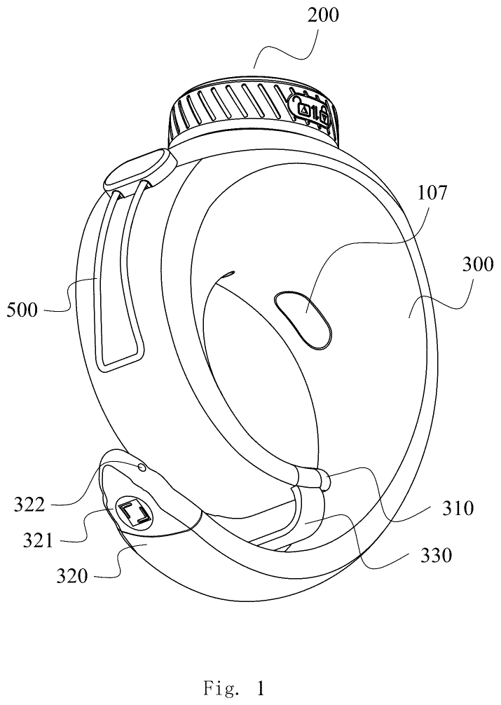

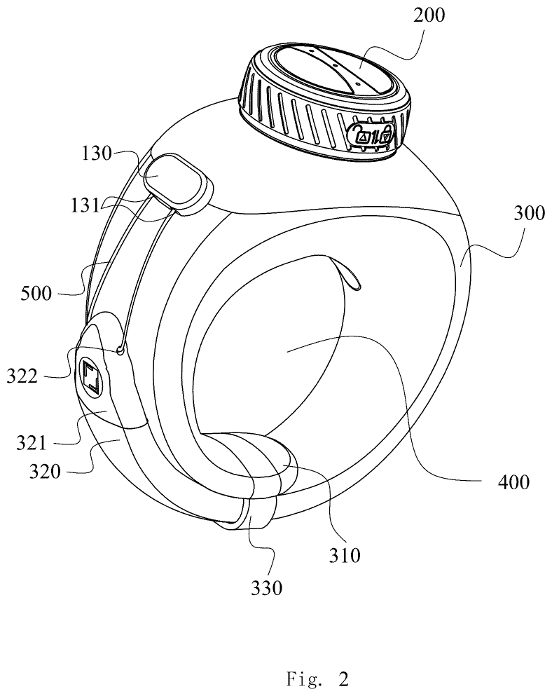

Referring to FIGS. 1-3, a vibrating massage ring includes a semi-annular body 100, a knob assembly 200 located at the top of the semi-annular body 100, and a silicone sleeve 300 wrapped around the semi-annular body 100. The silicone sleeve 300 has opposite first end 310 and second end 320, the firs end 310 is connected with the second end 320 so that the silicone sleeve 300 can surround a wearing cavity 400. The second end 320 is provided with a string 500, and the ends 501 of the string 500 are fixedly provided on the knob assembly 200. The knob assembly 200 is rotated to wind or unwind the string 500, so as to control the size of the overlapping area of the first end 310 and the second end 320 to adjust the size of the wearing cavity 400.

The firs end 310 is provided with a guiding ring 330, and the second end 320 can pass through the guiding ring and attach to the first end 310 to form an overlapping area. It should be understood that, a connection manner of the first end 310 and the second end 320 is not limited to the foregoing solution, and a person skilled in the art may flexibly set another connection manner according to his requirement.

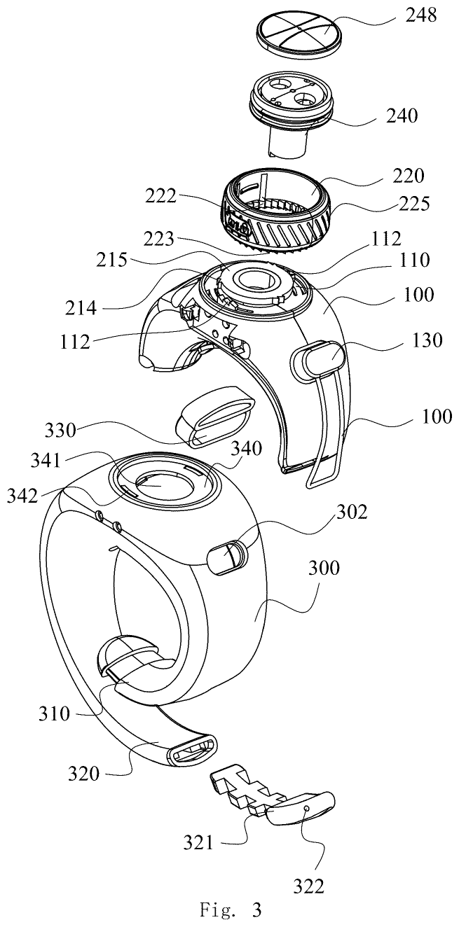

Referring to FIGS. 3-6, the outer surface of the semi-annular body 100 is provided with a knot base 110 with a first base hole 111. The knob assembly 200 is mounted on the knot base 110. Preferably, the knot base 110 is arranged on the middle of the outer surface of the semi-annular body 100. A battery 120 is provided in the semi-annular body 100 under the knot base 110. The silicone sleeve 300 is provided with a mounting base 340 at a position corresponding to the knob base 110 for mounting the rotating drum 220 described below. The mounting base 340 is provided with a second base hole 341 through which a string winding drum 210 described below can pass.

Referring to FIGS. 3 and 6-7, the knot assembly 200 includes the string winding drum 210 and the rotating drum 220. The string winding drum 210 is cylindrical in shape with a bottom 211 movably defined inside the semi-annular body 100. Two ends 501 of the string 500 is fixed on the bottom of the string winding drum 210. Specifically, the bottom of the string winding drum 210 is provided with two string holes 212 for the two ends 501 of the string 500 to pass through and be fixed with the string winding drum 210. The ends 501 of the string 500 is fixed to the string winding drum 210 by bonding, or the ends 501 of the string 500 is formed into a ball with a volume larger than that of the string hole 212.

The top 213 of the string winding drum 210 passes through the first base hole 111 on the knob base 110 and the second base hole 341 on the mounting base 340 to extend out of the semi-annular body 100 and the silicone sleeve 300, and the outer surface of the top 213 of the string winding drum 210 is provided with a first clamping teeth 214. Specifically, a convex ring 215 is provided on the outer surface of the top 213 of the string winding drum 210, and the first clamping teeth 214 are distributed on the periphery of the convex ring 215. The number of the first clamping teeth 214 is preferably 2-8.

The rotating drum 220 is cylindrical in shape and sleeved outside the top 213 of the string winding drum 210, an inner wall of the bottom 221 of the rotating drum 220 is provided with second clamping teeth 222, and the bottom surface of the rotating drum 220 is provided with third clamping teeth 223. The knob base 110 is provided with fourth clamping teeth 112. The mounting base 340 is provided with teeth holes 342 at positions corresponding to the fourth clamping teeth 112 for the fourth clamping teeth 112 to pass through and mesh with the third clamping teeth 223. The first clamping teeth mesh with the second clamping teeth 222. An external force overcomes the resistance of the fourth teeth 112 to the third teeth 223, so as to rotate the rotating drum 220, and the string winding drum 210 is driven to rotate by the cooperation of the second teeth 222 and the first teeth 214, so that the string 500 is wound around the string winding drum 210 or the string 500 wound around the string winding drum 210 is released, so that the overlapped area between the second end 320 and the first end 310 is increased or decreased, thereby adjusting the size of the wearing cavity 400. After the external force is removed, the rotating drum 220 no longer rotates because the fourth tooth 112 blocks the third tooth 223, and the string winding drum 210 no longer rotates any more.

The knob assembly 200 further includes a fixing plate 230 and a positioning step post 240. The fixing plate 230 is fixedly disposed in the semi-annular body 100, and the bottom 211 of the string winding drum 210 is movably disposed on the fixing plate 230. The bottom 241 of the positioning step post 240 passes through the string winding drum 210 and is fixed to the fixing plate 230, and the fixed method thereof is welding and screw connection, etc. Preferably, a screw hole 242 is provided in the bottom 241 of the positioning step post 240, and a screw (not shown) passes through the fixing plate 230 and is inserted into the screw hole 242, so as to fix the positioning step post 240 on the fixing plate 230.

The step wall 243 of the positioning step post 240 abuts against the top 213 of the string winding drum 210 to limit it and prevent the displacement thereof from affect the cooperation between the first clamped teeth 214 and the second clamped teeth 222. Preferably, a limiting ring 216 is provided on the middle part of the outer wall of the string winding drum 210, and the outer diameter of the limiting ring 216 is greater than the diameter of the first base hole 111, so as to further limit the string winding drum 210, thereby preventing the displacement thereof from affecting the cooperation of the first clamping teeth 214 and the second clamping teeth 222. Preferably, the inner surface of the string winding drum 210 is provided with an inner ring 216, and a silicone ring 217 is provided between the inner ring 216, the top 213 of the string winding drum 210 and the outer wall of the bottom 241 of the positioning step post 240, thereby further preventing the displacement of the string winding drum 210 from affecting the cooperation of the first clamping teeth 214 and the second clamping teeth 222.

At least one annular flange 244 is disposed on an outer wall of the top 242 of the positioning step post 240, and each annular flange 244 is in an interference fit with the inner surface of the rotating drum 220. The external force overcomes the friction force between the annular flange 244 and the inner wall of the rotating drum 220 and pulls the rotating drum 220 in a direction away from the knob base 110, so that the first clamped teeth 214 are separated from the second clamped teeth 222, and the third clamped teeth 223 are separated from the fourth clamped teeth 112, thereby releasing the string winding drum 210. In this case, even if the rotating drum 220 is rotated, the string winding drum 210 does not rotate, and thus the string 500 cannot be wound or released to adjust the size of the overlapped area of the first end 310 and the second end 320, that is, the size of the wearing cavity 400 cannot be adjusted. The external force overcomes the friction force between the annular flange 244 and the inner wall of the rotating drum 220 and pushes the rotating drum 220 in the direction of the knob base 110, so that the first clamping teeth 214 meshed with the second clamping teeth 222, and the third clamping teeth 223 meshed with the fourth clamping teeth 112, thereby locking the string winding drum 210. The external force can drive the string winding drum 210 to rotate the rotating drum 220, so as to release or wind the string 500.

Preferably, a silicone coat 225 is provided outside the rotating drum 220 to protect it, thereby improving the comfort of a user handling the rotating drum 220 by hand. An outer surface of the rotating drum 220 and an inner surface of the silicone coat 225 are respectively provided with a rib and a groove matching each other, so that the two can match and be connected. The outer surface of the silicone coat 225 is further provided with protrusions to increase friction with the hand of the user, so as to facilitate the rotation of the rotating drum 220.

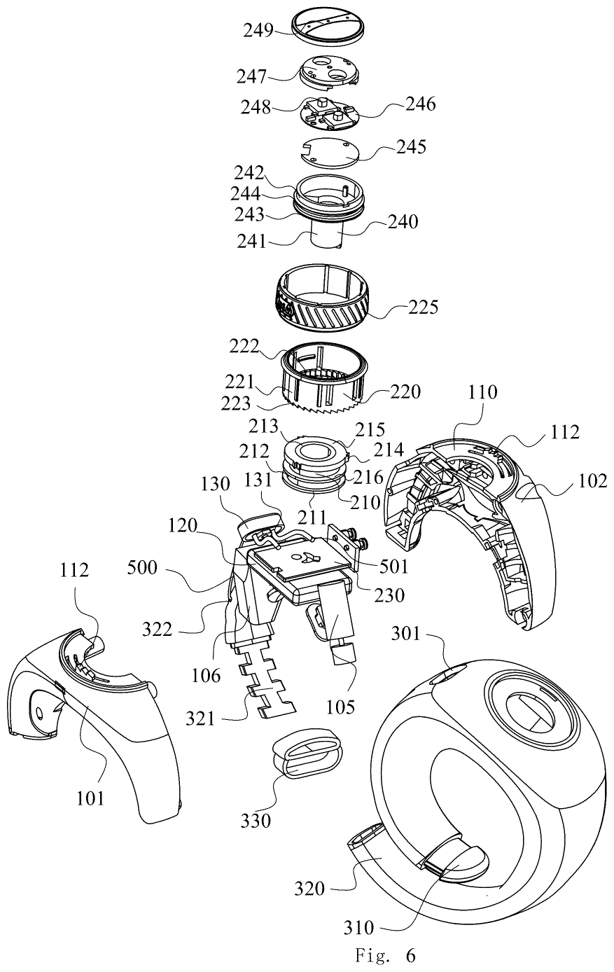

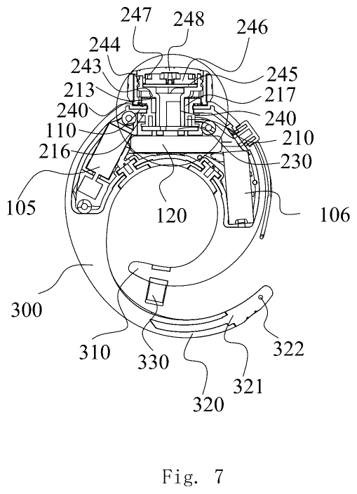

Referring to FIGS. 6-7, A PCB sticking plate 245 is arranged on the top of the positioning step post 240, a PCB lamp board 246 is fixedly arranged on the PCB sticking plate 245, and a PCB stop lamp board 247 is arranged on the PCB lamp board 246. The led lamp 248 is arranged on the PCB lamp board 246, so that it is convenient for a user to wear the massage ring in a dark environment.

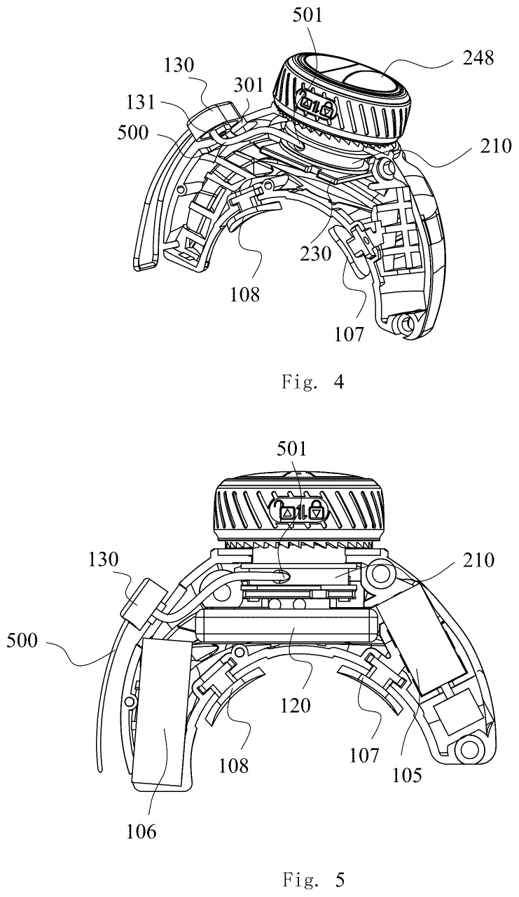

Referring to FIGS. 4-5, the outer surface of the semi-annular body 100 is provided with a waterproof silicone seat 130 at a position close to the second end 320, two through holes 131 penetrate through the side surface of the waterproof silicone base 130 from the bottom surface thereof through which the string 500 penetrates, so that the string 500 is introduced into the interior of the semi-annular body 100 from the exterior thereof. Correspondingly, the silicone sleeve 300 is provided with a mounting hole 302 as a position corresponding to the waterproof silicone seat 130 for it to pass through and leak out of the silicone sleeve 300. The waterproof silicone seat 130 filters water mist and dust on the string 500, so as to prevent the string 500 from bringing the water mist and dust into the massage ring.

Referring to FIGS. 6-7, a silica gel cap 249 is further provided on the top of the positioning step post 240 to prevent dust and water mist from entering the wearable massage ring.

Preferably, referring to FIGS. 3 and 6, the second end 320 of the silicone sleeve 300 is fixedly provided with a guiding member 321 extending out of the second end 320 and provided with a string hole 322 for the string 500 to pass through. The second end 320 is fixedly connected to the guiding member 321 by an adhesive, or the second end 320 and the guiding member 321 are respectively provided with clamping grooves or flanges which are mutually clamped to be matched.

Referring to FIGS. 4-6, the semi-annular body 100 comprises a left housing 101 and a right housing 102, which are respectively provided with a connecting column 103 and a connecting hole 104 cooperated with each other to assemble the left housing 102 and the right housing 103. The battery 120, a motor 105, and a PCB board 106 are disposed in the semi-annular body 100. The motor 105 is electrically connected to the battery 120 to charge the semi-annular body 100. Preferably, the battery 120 is arranged below the knob assembly 200, and the motor 105 and the PCB 106 are respectively arranged at two sides of the battery 120. The semi-annular body 100 is further provided with a first electric shock member 107 and a second electric shock member 108 penetrating the silicone sleeve 300 and contact the skin of the user when the user wears the vibration massage ring. The PCB 106 is electrically connected to the battery 120, the first electric shock member 107 and the second electric shock member 108 to supply power thereto.

The disclosure is described in further detail with reference to specific preferred embodiments, and it cannot be determined that the specific implementation of the disclosure is only limited to these descriptions. For a person of ordinary skill in the art to which the disclosure belongs, on the premise of not departing from the concept of the disclosure, the architecture form of the disclosure can be flexible and varied, and a series of products can be derived. Only a few simple deductions or replacements should be considered as belonging to the scope of protection defined by the claims as filed.

What is claimed is:

1. A vibrating massage ring, comprising a semi-annular body, a knob assembly located at a top of said semi-annular body, and a silicone sleeve wrapped around said semi-annular body; said silicone sleeve has opposite first end and second end, said firs end is connected with said second end so that said silicone sleeve can surround a wearing cavity; said second end is provided with a string, and ends of said string are fixedly provided on said knob assembly; said knob assembly is rotated to wind or unwind said string, so as to control a size of said overlapping area of said first end and said second end to adjust a size of said wearing cavity.

2. The vibrating massage ring according to claim 1, wherein an outer surface of said semi-annular body is provided with a knot base with a first base hole; said silicone sleeve is provided with a mounting base at a position corresponding to said knob base; said knob assembly is mounted on said knot base and includes said string winding drum and said rotating drum; said string winding drum is cylindrical in shape with a bottom movably defined inside said semi-annular body a top extending out of said knot base and said mounting base; said ends of said string are fixed on said bottom of said string winding drum; said rotating drum is cylindrical in shape and sleeved outside said top of said string winding drum, an inner wall of a bottom of said rotating drum is provided with second clamping teeth, and a bottom surface of said rotating drum is provided with third clamping teeth; said knob base is provided with fourth clamping teeth; said first clamping teeth mesh with said second clamping teeth, said third clamping teeth mesh wish said fourth clamping teeth.

3. The vibrating massage ring according to claim 2, wherein said knob assembly further includes a fixing plate and a positioning step post; said fixing plate is fixedly disposed in said semi-annular body, and said bottom of said string winding drum is movably disposed on said fixing plate; a bottom of said positioning step post passes through said string winding drum and is fixed to said fixing plate; a step wall of said positioning step post abuts against said top of said string winding drum, a limiting ring is provided on a middle part of a outer wall of said string winding drum, and an outer diameter of said limiting ring is greater than a diameter of said first base hole, an inner surface of said string winding drum is provided with an inner ring, and a silicone ring is provided between said inner ring, said top of said string winding drum, and said outer wall of said bottom of said positioning step post, thereby preventing a displacement of said string winding drum from affecting said cooperation of said first clamping teeth and said second clamping teeth.

4. The vibrating massage ring according to claim 1, wherein said firs end is provided with a guiding ring, and said second end can pass through said guiding ring and attach to said first end to form an overlapping area.

5. The vibrating massage ring according to claim 3, wherein at least one annular flange is disposed on an outer wall of said top of said positioning step post, and each annular flange is in an interference fit with said inner surface of said rotating drum; a external force pulls said rotating drum in a direction away from said knob base so that said first clamped teeth are separated from said second clamped teeth, and said third clamped teeth are separated from said fourth clamped teeth, thereby releasing said string winding drum; said external force pushes said rotating drum in a direction of said knob base, so that said first clamping teeth meshed with said second clamping teeth, and said third clamping teeth meshed with said fourth clamping teeth, thereby locking said string winding drum.

6. The vibrating massage ring according to claim 3, wherein a PCB sticking plate is arranged on said top of said positioning step post, a PCB lamp board is fixedly arranged on said PCB sticking plate, a led lamp is arranged on said PCB lamp board.

7. The vibrating massage ring according to claim 1, wherein an outer surface of said semi-annular body is provided with a waterproof silicone seat at a position close to said second end, two through holes penetrate through a side surface of said waterproof silicone base from a bottom surface thereof through which said string penetrates.

8. The vibrating massage ring according to claim 1, wherein said second end of said silicone sleeve is fixedly provided with a guiding member extending out of said second end and provided with a string hole for said string to pass through.

9. The vibrating massage ring according to claim 1, wherein said semi-annular body is further provided with a first electric shock member and a second electric shock member penetrating said silicone sleeve.

10. The vibrating massage ring according to claim 1, wherein a battery, a motor, and a PCB board are disposed in said semi-annular body; said battery is arranged below said knob assembly, and said motor and said PCB are respectively arranged at two sides of said battery.
